(19) United States
(12) Patent Application Publication
(10) Pub. No.: US 2010/0011537 A1
(43) Pub. Date: Jan. 21, 2010

(54) Structure of a foot member of a baby mesh bed

(76) Inventor: Ying-Hsiung Cheng, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,004

(22) Filed: Jul. 15, 2008

(51) Int. Cl. B60B 33/04; A47D 15/00

(52) U.S. Cl. 16/31 R; 5/658

(57) ABSTRACT

A foot member of a baby mesh bed includes a base part, and a tubular part; the tubular part is securely joined on a lower end of an upright rod of the mesh bed, and has two embedded protrusions on an outer side, and a detainment hole; the base part has an uppermost joining portion, which has two embedding cavities, and a wedge piece thereon; the base part and the tubular part are joined together with the embedded protrusions being embedded in the embedding cavities respectively, and with the wedge piece of the base part being detained in the detainment hole of the tubular part; the base part can be separated from the tubular part for the mesh bed to occupy less space, thus being able to be packaged in a smaller case.

### BACKGROUND OF THE INVENTION

1. Field of the invention

The present invention relates to a foot member of a baby mesh bed, more particularly one, which includes a tubular part, and a base part capable of being separated from the tubular part for the baby mesh bed to occupy less space; thus, the baby mesh bed can be packaged in a smaller case, and it takes the manufacturers less expense to store and transport the baby mesh bed.

2. Brief Description of the Prior Art

Referring to FIG. 7, a currently existing baby mesh bed 5 includes a body 51, four upright rods 52, four foot members 53, connecting rods 54, and a middle base 55. The upright rods 52 are joined to four corners of the body 51 respectively while the foot members 53 are securely joined to lower ends of the upright rods 52 respectively. The connecting rods 54 are pivoted to the foot members 53 respectively at outward ends thereof, and pivoted to the middle base 55 at inward ends thereof. The baby mesh bed 5 can be moved between a stretched in-use position and a folded one. When the mesh bed 5 is in the stretched in-use position, the connecting rods 54 will be horizontal. And, when the mesh bed 5 is folded to be easy to store and transport, the connecting rod 54 will be substantially upright and close to the upright rods 52.

The above baby mesh bed 5 has a drawback: the foot members 53 can't be separated into different parts to further reduce the dimensions of the baby mesh bed 5 when the mesh bed 5 is being packaged. Consequently, the mesh bed still has to be packaged in a relatively large case, and the extent of reduction of the storage and transportation cost isn't large enough.

### SUMMARY OF THE INVENTION

It is a main object of the present invention to provide an improvement on a foot member of a baby mesh bed, which includes two parts capable of being separated from each other for the mesh bed to occupy less space and be packaged in a smaller case, thus overcoming the above problems.

A foot member in accordance with an embodiment of the present invention includes a base part, and a tubular part. The tubular part is securely joined on a lower end of an upright rod of the mesh bed, and has two embedded protrusions on an outer side, and a detainment hole. The base part has an uppermost joining portion, which has two embedding cavities, and a wedge piece thereon. The base part and the tubular part are joined together with the embedded protrusions being embedded in the embedding cavities respectively, and with the wedge piece of the base part being detained in the detainment hole of the tubular part. The base part can be separated from the tubular part, and placed in the space between other parts of the mesh bed when the baby mesh bed is packaged in a folded position. Therefore, the baby mesh bed can be packaged in a smaller case, and it takes the manufacturers less expense to store and transport the baby mesh bed.

### BRIEF DESCRIPTION OF THE DRAWINGS

The present invention will be better understood by referring to the accompanying drawings, wherein:

FIG. 1 is a perspective view of a frame of a baby mesh bed according to the present invention,

FIG. 2 is an exploded perspective view of the present invention (1),

FIG. 3 is an exploded perspective view of the present invention (2),

FIG. 4 is a horizontal sectional view of the present invention,

FIG. 5 is a lateral sectional view of the present invention,

FIG. 6 is a perspective view of the present invention, and

FIG. 7 is a sectional view of the prior baby mesh bed as described in Background.

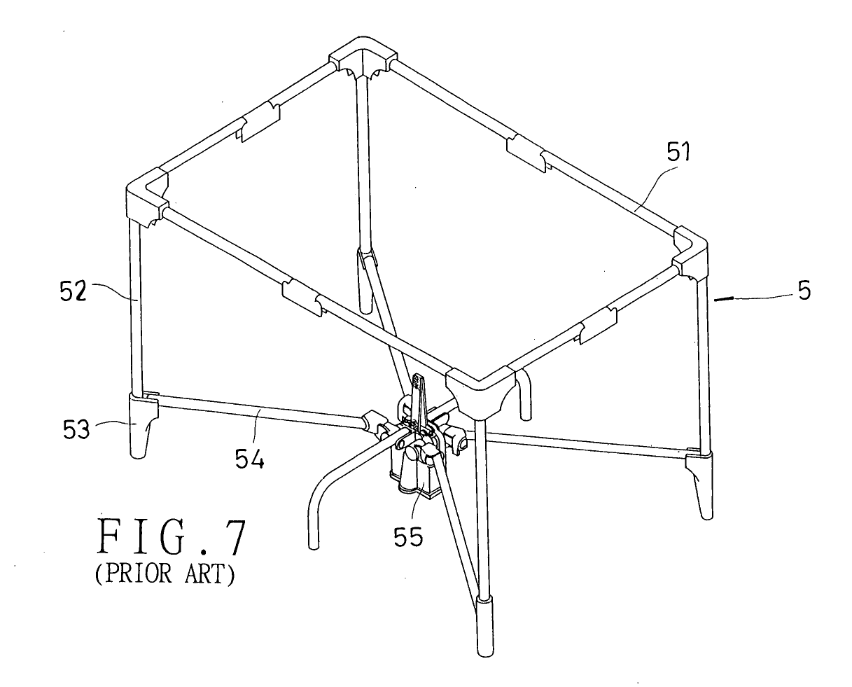

### DETAILED DESCRIPTION OF THE PREFERRED EMBODIMENTS

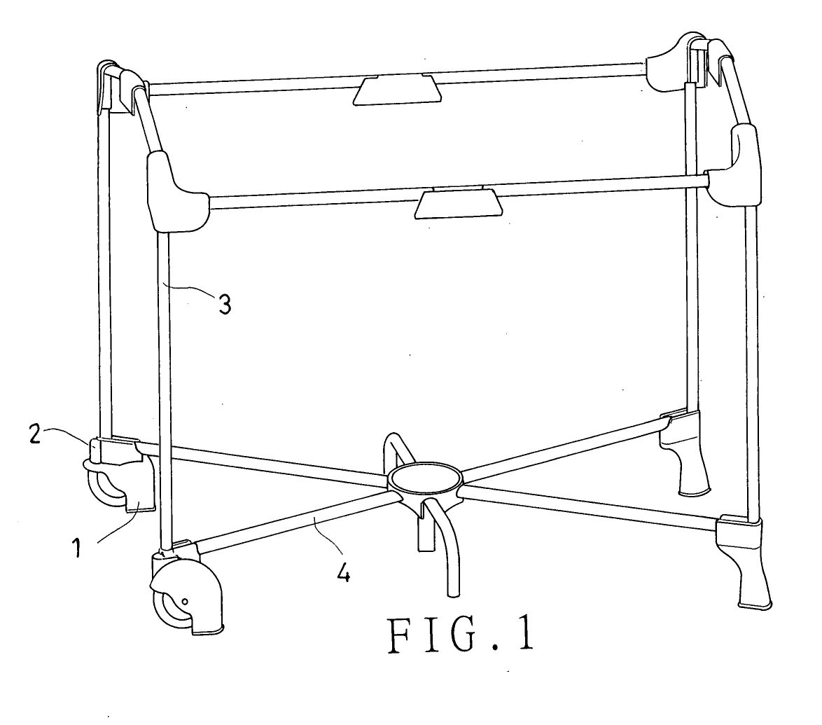

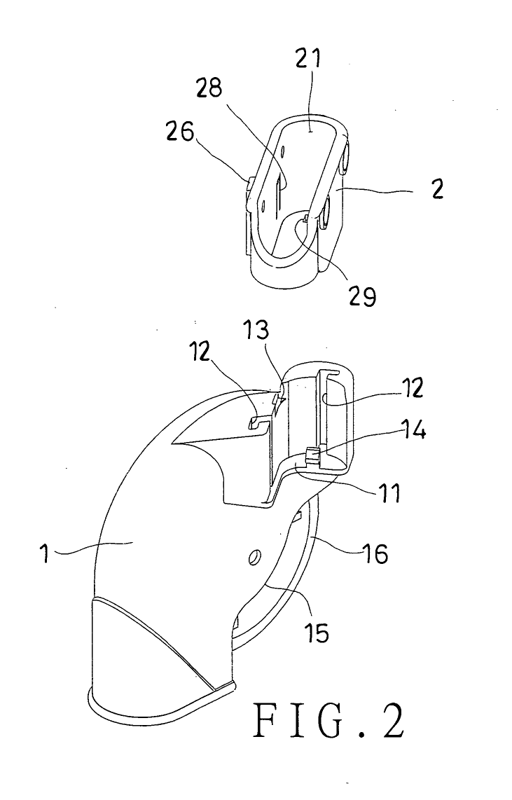

Referring to FIGS. 1 and 2, a preferred embodiment of a foot member of a baby mesh bed in the present invention consists of a base part 1, and a tubular part 2. The baby mesh bed includes a middle base, four upright rods 3, and four connecting rods 4; the foot member is securely joined on a lower end of a corresponding upright rod 3; one of the connecting rods 4 is pivoted on the foot member at an outward end, and pivoted to the middle base at an inward end thereof.

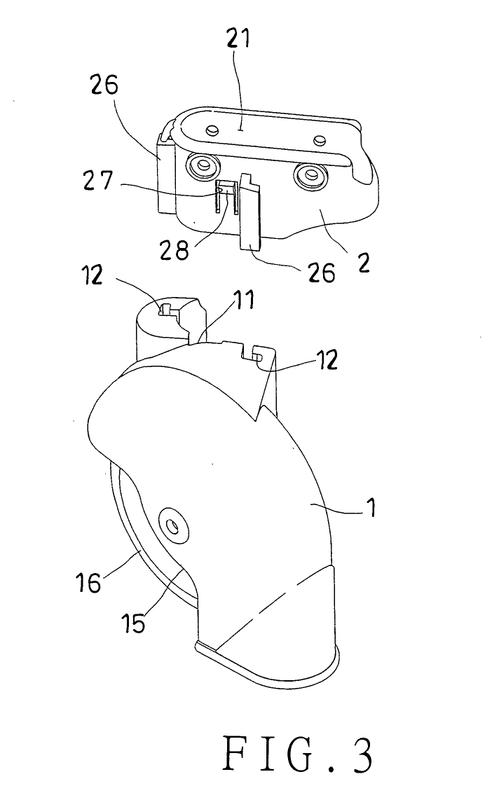

Referring to FIG. 3, the base part 1 has an uppermost joining portion 11, which has two polygonal embedding cavities 12 thereon, and which has a stopping protrusion 13 on an upper edge thereof. The uppermost joining portion 11 further has a wedge piece 14 on a bottom. The base part 1 has a lower hollow holding portion 15 under the uppermost joining portion 11, and a wheel 16 is held in and pivoted to the lower hollow holding position 15.

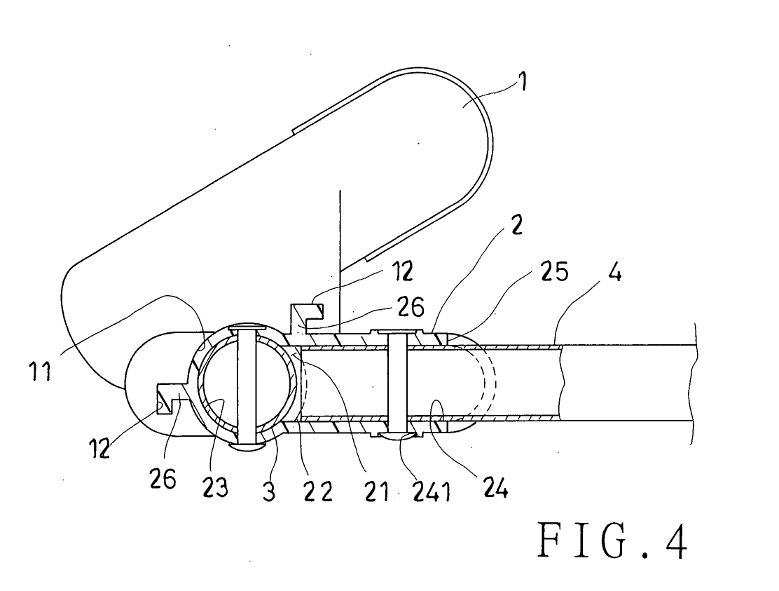

Referring to FIG. 4, the tubular part 2 has a hollow holding portion 21, and a stopping plate part 22, which is formed in the hollow holding portion 21 to divide the hollow holding portion 21 into first and second holding portions 23 and 24; the lower end of the upright rod 3 is held in and securely joined to the first holding portion 23 of the tubular part 2 while the outward end of the connecting rod 4 is held in the second holding portion 24. The second holding portion 24 has pivotal holes 241, and a gap 25 thereon; the connecting rod 4 is further pivoted on the pivotal holes 241 of the second holding portion 24, and it will be held in the gap 25 when it is in a horizontal in-use position.

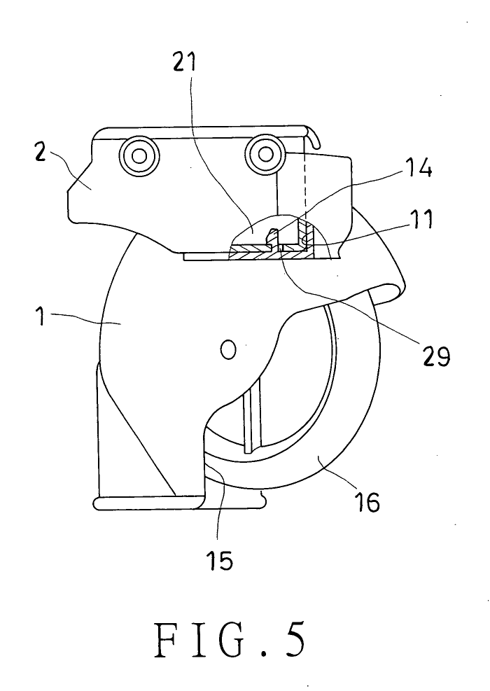

Referring to FIG. 3 again, the tubular part 2 has two polygonal embedded protrusions 26 on an outer side thereof, which have the same shape as the polygonal embedding cavities 12 of the base part 1. The tubular part 2 has a through hole 27, and a stopping protrusion 28, which is held in the through hole 27, and adjoins a lower edge of the through hole 27 at a lower end thereof. The hollow holding portion 21 of the tubular part 2 has a detainment hole 29 on a bottom, as shown in FIG. 5.

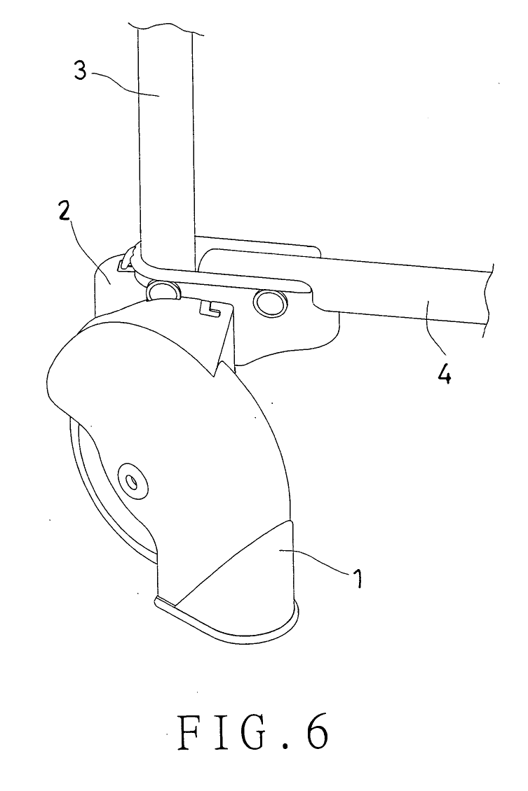

In assembly, the tubular part 2 and the base part 1 are firmly joined together with the polygonal embedded protrusions 26 being embedded in the polygonal embedding cavities 12 respectively, the stopping protrusion 28 being propped against the stopping protrusion 13, and with the wedge piece 14 being inserted in the detainment hole 29. Therefore, the base part 1 can be separated from the tubular part 2 for the baby mesh bed to occupy less space; the base part 1 can be placed in the space between other parts of the baby mesh bed when the baby mesh bed is in a folded position and packaged in a box; thus, the baby mesh bed is easier to store and transport, and can be contained in a smaller packaging box. Consequently, the storage and transportation cost can reduce. And, a consumer can easily join the base part 1 and the tubular part 2 together by means of embedding the polygonal embedded protrusions 26 of the tubular part 2 in the polygonal embedding cavities 12 of the base part 1, and making the stopping protrusion 28 propped against the stopping protrusion 13 as well as making the wedge piece 14 pass through the detainment hole 29, as shown in FIGS. 5 and 6.

From the above description, it can be seen that the baby mesh bed according to the present invention has the following advantages:

1. The foot member of the baby mesh bed consists of the base part and the tubular part, which are joined together in an easily separable manner; the base part can be separated from the tubular part, and placed in the space between other parts of the mesh bed when the mesh bed is packaged in a folded position. Therefore, the baby mesh bed can be packaged in a smaller case, and it takes the manufacturers less expense to store and transport the baby mesh bed.

2. When the base part and the tubular part of the foot member are joined together, the polygonal embedded protrusions will be embedded in the polygonal embedding cavities, the stopping protrusion propped against the stopping protrusion, and the wedge piece will be detained in the detainment hole to firmly fix the base part to the tubular part. Therefore, the present invention is safe to use.

1. Foot member structure of a baby mesh bed, comprising
a base part; the base part having an uppermost joining portion; the uppermost joining portion having a plurality of embedding cavities thereon; and
a tubular part; the tubular part having a plurality of embedded protrusions on an outer side thereof; the base part and the tubular part being joined together when with the embedded protrusions of the tubular art are embedded in corresponding embedding cavities of the base part.

2. The foot member structure of a baby mesh bed as claimed in claim 1, wherein the embedded protrusions and the embedding cavities are polygonal.

3. The foot member structure of a baby mesh bed as claimed in claim 1, wherein the uppermost joining portion of the base part has a stopping protrusion on an upper edge thereof, and the tubular part has an outward stopping protrusion propped against the stopping protrusion of the uppermost joining portion of the base part.

4. The foot member structure of a baby mesh bed as claimed in claim 3, wherein the tubular part has a through hole, and the outward stopping protrusion is held in the through hole, and adjoins a lower edge of the through hole.

5. The foot member structure of a baby mesh bed as claimed in claim 1, wherein the uppermost joining portion of the base part has a wedge piece on a bottom thereof, and the tubular part has a hollow holding portion; the hollow holding portion of the tubular part having a detainment hole on a bottom thereof, in which the wedge piece of the base part is detained.

6. The foot member structure of a baby mesh bed as claimed in claim 1, wherein the tubular part has a hollow holding portion, and a stopping plate part, which is formed in the hollow holding portion to divide the hollow holding portion into first and second holding portions; a lower end of an upright rod of the baby mesh bed being held in and joined to the first holding portion of the tubular part; the second holding portion having pivotal holes and a gap thereon; a connecting rod of the baby mesh bed being held in and pivoted to the second holding portion at one end thereof.

7. The foot member structure of a baby mesh bed as claimed in claim 1, wherein the base part has a lower hollow holding portion; a wheel being held in and pivoted to the lower hollow holding position.
